(19) United States
(12) Patent Application Publication
(10) Pub. No.: US 2006/0138730 A1
(43) Pub. Date: Jun. 29, 2006

(54) Impervious closure for powdered products

(76) Inventor: Jose Luis Igoa Marinelarena, Madrid (ES)

Correspondence Address: Henri Misrahi, 4000 Williams Blvd #1804, Aventura, FL, 33160, US

(21) Appl. No.: 10/516,510

(22) PCT Filed: Jun. 6, 2002
(86) PCT No.: PCT/ES02/00276

§ 371 Date: Dec. 1, 2004

(51) Int. Cl. F16J 15/54

(52) U.S. Cl. 277/578

(57) ABSTRACT

The invention relates to an impervious closure for pulverulent products, comprising a strip of felt fabric which is approximately 12 mm. thick. According to the invention, pressure is exerted on the fabric by a support flat bar which, in turn, is pushed by plate springs against a steel rotor. The aforementioned plate springs are fixed using a locknut and a regulating nut and said nuts can be used to adjust the pressure on the rotor and to obtain a suitable pressure.

### OBJECT OF THE INVENTION

The present invention is related to an impervious closure for pulverulent products, which facilitates an tight seal for this type of finely granulated products and which, applied in the rotor of different valves, guarantees the flow of the material within the desired path at all times, also preventing completely hte flow through other paths where the material is not intended to flow at the time, as will be explained in detail below.

### BACKGROUND OF THE INVENTION

At present there exist valves intended for these purposes, although the sealing system they offer consists of a plate resting on rubber, and due to the incorrect adjustment of the plate on the rubber or to the deterioration and hardening of the rubber, it leads to leaking of the material through undesired passages, thereby producing blockage in pumps and different machines, or contamination of materials including in silos for up to 5,000 Mt (metric tonnes) which spoils all of the material.

The impervious closure for pulverulent products, which is a considerable improvement on existing seals and overcomes existing problems, has been designed in order to solve these problems, as explained below.

### DESCRIPTION OF THE INVENTION

This impervious closure for pulverulent products of the invention is applied on a metal rotor and is made up of a strip of fabric pressed by a support flat bar which is pushed by plate springs against a steel rotor. An impervious closure is thus obtained, maintaining the predetermined desired pressure, as well as guaranteing the tightness even if the fabric wears down, since the springs correct it at all times.

In order to complement the description of the invention and with the objective of providing a better understanding of its characteristics, a set of figures are included with the present description in which, as non-limiting illustrations, the following is represented:

### DESCRIPTION OF THE DRAWINGS

FIG. 1 shows a detailed view of the impervious closure disclosed herein.

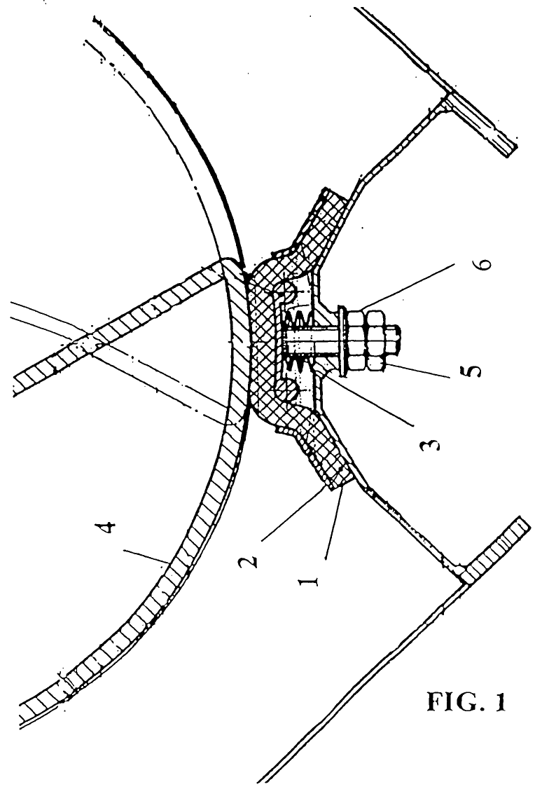

### PREFERRED EMBODIMENT OF THE INVENTION

The impervious closure for pulverulent products is achieved by way of an elastic support obtained by rubbing steel with approximately 12 mm. thick fabric material (1), which is pressed by a support flat bar (2), that is pushed by plate springs (3) against a steel rotor (4), said plate springs (3) being affixed using a locknut (5) and regulating nut (5) and said nuts can be used to adjust the pressure on the rotor and to obtain a suitable pressure.

It is not considered necessary to develop this description any further in order for any skilled in the art to be able to understand the scope of the invention and the advantages derivable from it. The terms in which this description is written should always be taken in wide, non-limiting sense.

The materials, form, shape and disposal of the items are open to variations, as long as they do not alter the essential characteristics of the invention that are claimed below.

1. A Leak-proof seal for pulverulent products including:
a strip of fabric (I) approximately 12 mm thick,
a support flat bar (2),
plate springs (3)
a locknut (5) and
an regulating nut (6),
Wherein:
the strip of fabric (1) is pressed by the support flat bar (2) and can be pushed by the plate springs (3) on a steel rotor (4),
said plate springs (3) are affixed to the strip of fabric (1) and the support flat bar (2) by way of the locknut (5) and the regulating nut which facilitates regulating and obtaining the appropriate pressure on the rotor (4).
